(19) United States
(12) Patent Application Publication
(10) Pub. No.: US 2026/0277019 A1
(43) Pub. Date: Sep. 17, 2026

(54) AERIAL IMAGE DISPLAY DEVICE AND METHOD FOR DISPLAYING 360-DEGREE IMAGES

(71) Applicant: INTERMAN Corporation, Kagoshima-shi (JP)

(72) Inventors: Yusuke AKAZAWA, Kagoshima-shi (JP); Shigeki UETABIRA, Kagoshima-shi (JP); Naofumi HIGASHIKAWAUCHI, Kagoshima-shi (JP)

(73) Assignee: INTERMAN Corporation, Kagoshima-shi (JP)

(21) Appl. No.: 19/560,570

(22) Filed: Mar. 9, 2026

(30) Foreign Application Priority Data
Mar. 11, 2025 (JP) 2025-038819

(51) Int. Cl. G02B 30/56; G06F 3/01

(52) U.S. Cl. CPC G02B 30/56; G06F 3/017

(57) ABSTRACT

An aerial image display device that allows visual recognition over a wide area of 360-degree space by using a spherical surface as a screen. This aerial image display device includes a computer and an image system controlled by the computer to project an image onto an imaging plane in the air, and causes the computer to execute: a step of inputting a 360-degree image; a step of defining a sphere in an area in the air including the imaging plane; a step of mapping the 360-degree image onto the surface of the sphere; and a step of projecting and displaying the surface of the sphere onto which the 360-degree image is mapped on the imaging plane. This sphere can be freely rotated by hand gestures.

### CROSS REFERENCE TO RELATED APPLICATIONS

The present application claims priority under 35 U.S.C. § 119 to Japanese Patent Application No. P2025-038819, filed on Mar. 11, 2025 including description, claims, drawings, and abstract. The contents of this application are herein incorporated by reference in their entirety.

### FIELD

The present invention relates to an aerial image display device and an aerial image display method for displaying 360-degree images.

### BACKGROUND

In recent years, 360-degree images have become rapidly widespread and are drawing attention in various fields. With this technology, users can view an object at any desired angle while freely moving their line of sight.

360-degree images are impactful, contain a large amount of information, and provide a sense of immersion; thus, they are actively used in corporate activities such as interior viewing of rooms in the real estate industry, providing simulated travel experiences in the tourism industry, and facility tours.

Furthermore, as 360-degree cameras have become easily available, it has become common for individuals to easily create and publish 360-degree images. In fact, it is now possible to view numerous 360-degree images in various fields even on internet video sites. An example of such a 360-degree camera is described in Japanese Patent Application Publication No. 2021-012099.

Generally, 360-degree images are recorded as a single flat image in formats such as panoramic, dome master, or cube map, by capturing 360 degrees in both vertical and horizontal directions using an omnidirectional 360-degree camera. When a user (viewer) watches the recorded 360-degree image, the data is rendered into an area (viewport) viewed from a specific viewpoint and played back as a flat image. Therefore, the user is looking at only one part of the 360-degree space.

Accordingly, an object of the present invention is to provide an aerial image display device and an aerial image display method that allow visual recognition over a wide area of 360-degree space by using a spherical surface as a screen.

### SUMMARY

To achieve at least one of the above-mentioned objects, reflecting one aspect of the present invention, a method for projecting an image onto an imaging plane in the air with an aerial image display device, comprises: a step of inputting a 360-degree moving image; a step of defining a sphere in an area in the air including the imaging plane; a step of mapping the 360-degree moving image onto the surface of the sphere; and a step of projecting and displaying the surface of the sphere, onto which the 360-degree moving image is mapped, as an aerial image on the imaging plane.

In accordance with one embodiment, the aerial image display device further comprises a motion sensor that detects coordinates of a user's hand located in the vicinity of the aerial image and transmits the detection result to the computer, wherein the motion sensor detects a hand movement performed by the user, rotation of the sphere is performed according to the detection result, and the direction of the rotation vector changes according to the hand movement performed by the user.

Also, in accordance with one embodiment, the 360-degree moving image is an entire celestial sphere image captured by a 360-degree camera.

In accordance with another aspect of the present invention, a method is provided for displaying an aerial image with an aerial image display device comprising a computer, an image system controlled by the computer to project an image onto an imaging plane in the air, and a motion sensor that detects coordinates of a user's hand located in the vicinity of the aerial image projected by the image system and transmits the detection result to the computer, the method comprising: a step of inputting a 360-degree image into the computer; a step of defining a sphere in an area in the air including the imaging plane; a step of mapping the 360-degree image onto the surface of the sphere; and a step of projecting and displaying the surface of the sphere, onto which the 360-degree image is mapped, on the imaging plane; wherein the motion sensor detects a hand movement performed by the user, rotation of the sphere is performed according to the detection result, the 360-degree image rotates accordingly, and wherein the user can freely rotate the 360-degree image on the surface of the sphere vertically, horizontally, and diagonally by moving their hand vertically, horizontally, and diagonally.

In accordance with a further aspect of the present invention, an aerial image display device comprises a computer; a visual system controlled by this computer to project images into the air as aerial images; and a motion sensor that detects the coordinates of a user's hand performed near the projected aerial image and transmits the detection results to the computer, the computer being configured to perform: a step of inputting a 360-degree image into the computer; a step of defining a sphere in an area in the air including the imaging plane; a step of mapping the 360-degree image onto the surface of the sphere; and a step of projecting and displaying the surface of the sphere, onto which the 360-degree image is mapped, on the imaging plane; wherein the motion sensor detects a hand movement performed by the user, rotation of the sphere is performed according to the detection result, the 360-degree image rotates accordingly, and wherein the user can freely rotate the 360-degree image on the surface of the sphere vertically, horizontally, and diagonally by moving their hand vertically, horizontally, and diagonally.

In accordance with the aerial image display device and method relating to the present invention, by using a spherical surface as a screen, 360-degree images can be visually recognized over a wide area.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view showing an aerial image display device 1 that executes an embodiment of the aerial image display method according to the present invention.

FIG. 2 is a cross-sectional view taken along line A-A of FIG. 1 showing the aerial image display device 1.

FIG. 3 is a diagram for explaining the process of mapping a 360-degree image based on equirectangular projection onto a spherical surface in the aerial image display method according to the present invention.

FIG. 4 is a diagram showing an example where a 360-degree image is mapped only to the front side of a sphere in the aerial image display method according to the present invention.

FIG. 5 is a diagram showing an example where a 360-degree image is mapped only to the back side of a sphere in the aerial image display method according to the present invention.

FIG. 6 is a diagram for explaining the aerial image display method according to the present invention, showing a state where a sphere serving as a 360-degree image screen is touched and rotated by hand.

FIG. 7 is a diagram for explaining the operation of the embodiment of the aerial image display method according to the present invention, and is a flowchart showing the process of touching and rotating a sphere serving as a 360-degree image screen by hand.

FIG. 8 is a diagram showing a state in which a light-shielding plate 50 is placed over the liquid crystal display 10 in the aerial image display device 1 of FIG. 1.

FIG. 9 is a plan view showing the light-shielding plate 50 of FIG. 8.

### DETAILED DESCRIPTION

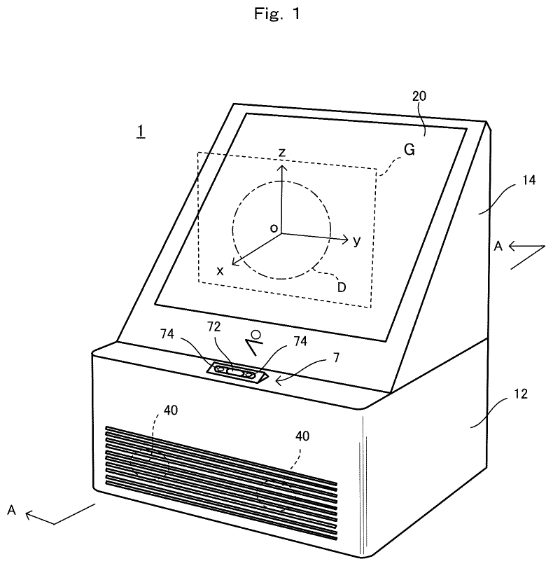

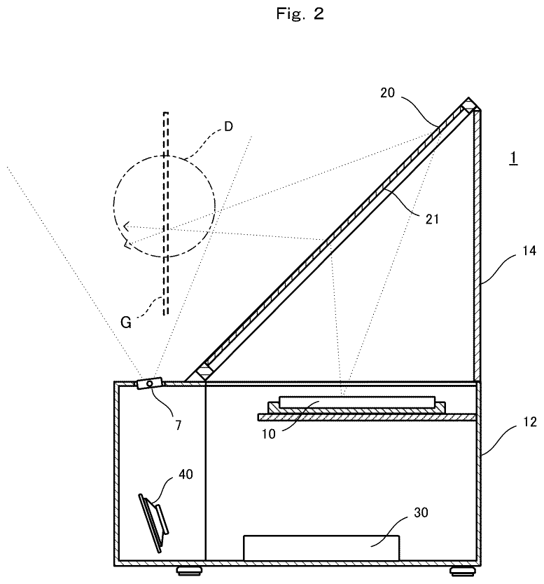

In what follows, an embodiment of an aerial image display method according to the present invention will be described below with reference to the accompanying drawings. This method is implemented as a program for an aerial image display device. FIG. 1 is a perspective view showing an aerial image display device 1 for executing an embodiment of the present invention. FIG. 2 is a cross-sectional view taken along line A-A of FIG. 1 showing the aerial image display device 1 in a used state.

### Structure of Aerial Image Display Device

As shown in FIG. 1 and FIG. 2, the aerial image display device 1 includes a liquid crystal display 10 and an optical plate 20 as essential components. The aerial image display device 1 further includes an information processing device 30 that controls the liquid crystal display 10, a speaker 40, and the like. Here, the liquid crystal display 10, the speaker 40, and the information processing device 30 are housed inside a lower housing 12 and are connected to each other by signal lines (omitted in the figures).

The information processing device 30 is substantially a small computer and is composed of a CPU (Central Processing Unit), a ROM (Read Only Memory), a RAM (Random Access Memory), a storage device for storing various programs and data, an input/output interface, and the like. As the input/output interface, for example, a USB port or a wireless LAN such as Wi-Fi is implemented. The information processing device 30 outputs an image signal to the liquid crystal display 10 and performs a display that serves as the source of the aerial image. Additionally, the information processing device 30 outputs an audio signal to the speaker 40 to generate guidance voices, sound effects, and the like. For this information processing device 30, a commercially available general-purpose small personal computer or a general-purpose tablet can also be utilized.

The liquid crystal display 10 is housed in the lower housing 12, which is rectangular in plan view and open at the top, and is supported substantially horizontally with its display screen facing upward. Further, the optical plate 20 is fitted into an upper housing 14 such that its incident surface 21 faces downward and obliquely faces the display screen of the liquid crystal display 10. Here, the optical plate 20 and the liquid crystal display 10 are fixed at an angle of approximately 45 degrees.

As such an optical plate 20, for example, a retro-transmissive optical imaging element (two-face orthogonal reflector) described in Japanese Patent Application Publication No. 2011-175297 can be used. This optical imaging element is realized by arranging a large number of planar light-reflecting portions perpendicular to each other at a constant pitch. Besides this, a structure such as a dihedral corner reflector in which reflective surfaces are formed on the side surfaces of square holes, as described in Japanese U.S. Pat. No. 4,900,618, may be used.

The upper housing 14 constituting the aerial image display device 1 is designed to be easily separable from the lower housing 12. By separating the upper housing 14, maintenance and adjustment inside the lower housing 12 can be performed easily, and the height during transportation can be reduced.

As shown in FIG. 2, light from the display screen of the liquid crystal display 10 enters the optical plate 20, is reflected twice inside the optical plate 20, and exits to the opposite side. As a result, an aerial image is formed as a real image in the space on the opposite side, with the optical plate 20 serving as a plane of symmetry. In this case, to achieve a clearer aerial image, it is desirable that external light is not added to the light from the liquid crystal display 10. In FIG. 2, reference symbol G indicates an imaging region corresponding to the display surface of the liquid crystal display 10. This imaging region serves as the imaging plane for the display image of the liquid crystal display 10.

Furthermore, a three-dimensional motion sensor 7 consisting of an infrared LED 72 and a pair of infrared cameras 74 is provided on the front side of the lower housing 12. With this motion sensor 7, the movements of the user's hand are detected precisely in three dimensions. The detection range of the motion sensor 7 is defined by the emission angle of the infrared LED 72 and the field of view of the infrared cameras 74. Such a motion sensor 7 can be a commercially available product, such as the Leap Motion Controller 2 sold by Ultraleap Ltd.

In particular, this three-dimensional motion sensor 7 is mounted such that its tilt angle is adjustable. Specifically, the motion sensor 7 is housed in a housing member capable of rotating within a certain angular range (here, ±20 degrees) around a rotation axis perpendicular to the plane of the cross-sectional view in FIG. 2. Here, the motion sensor 7 is adjusted so that the center of its detection range is shifted more toward the user than the center of the imaging region G. By adjusting in this way, the effective operation detection range can be maximized.

Although not shown here, it is preferable to place the aerial image display device 1 on a table of appropriate height so that the aerial image can be visually recognized at eye level. In particular, one equipped with a lifting device that allows for free height adjustment is suitable. Examples of such a lifting device include the electric lifting device “Mario N” sold by Yamato Metal Manufacturing Co., Ltd.

Normally, such an aerial image display device is used as a clerical input device for reception systems or the like. That is, if a non-contact interface screen is displayed as an aerial image, gesture operations such as touching the non-contact interface screen with a finger can be performed. The motion sensor 7, consisting of the infrared LED 72 and infrared cameras 74, detects such operations, and corresponding operation signals are sent to the information processing device 30 for predetermined processing. The operation interface includes controls such as buttons, checkboxes, and drop-down menus, for example. Therefore, a completely non-contact interface can be realized with the same usability as a conventional touch panel.

### Spherical Display of 360-Degree Images

As described above, an aerial image is displayed in the imaging region G corresponding to the display surface of the liquid crystal display 10. Although the aerial image is two-dimensional, a sense of depth (stereoscopic effect) is achieved by virtually generating a three-dimensional object in the three-dimensional space near the imaging region G and perspective-projecting this three-dimensional object onto the screen of the liquid crystal display 10. As a result, a three-dimensional object floating in the air becomes visually recognizable.

In this embodiment, a sphere D is displayed as this three-dimensional object. The center of the sphere D coincides with the center of the imaging region G, and the diameter is approximately half the width of the imaging region G. Then, the surface of this the sphere D is used as a screen for displaying an entire celestial sphere image (360-degree image). That is, the entire celestial sphere image is mapped onto the surface (spherical surface) of the sphere D and displayed.

For the entire celestial sphere image, data captured with a 360-degree camera or the like is used. Therefore, the 360-degree image used in this embodiment is an image captured as an omnidirectional image with a solid angle of 4π, with the viewpoint at the center. Here, as a typical and preferred specific example of the present invention, a 360-degree image in this narrow sense, where the viewpoint is at the center, is taken up.

However, the spirit of the present invention is also effective for 360-degree images in a slightly broader sense, i.e., 360-degree images where the viewpoint is not at the center. In other words, any 360-degree image created with image processing software without using a 360-degree camera may be used.

Here, an explanation will be given using data of 360 degrees vertically and horizontally that shows the movement of stars in the night sky as an example. Accordingly, in this case, the 360-degree video (360-degree moving image) will be rendered onto the surface of the sphere D. In particular, the diurnal motion of the starry sky due to the Earth's rotation is expressed as an entire celestial sphere image.

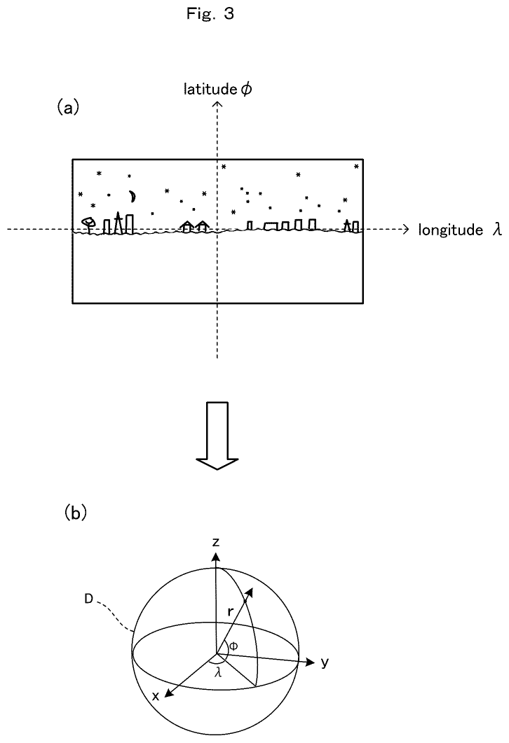

The 360-degree video is generated, for example, as an MP4 format video file based on equirectangular projection. In equirectangular projection, an entire celestial sphere image is represented by rectangular image data with the vertical and horizontal axes representing latitude and longitude, respectively (see FIG. 3(a)). Therefore, for mapping onto a spherical surface, let r be the radius of the sphere D and the center of the sphere D be the coordinate origin; each point on the vertical and horizontal axes (latitude φ and longitude λ) of the image data may be converted into a point (x, y, z) on the spherical surface as shown in the following equations (see FIG. 3(b)).
x=r·cosφ·cosλ
y=r·cosφ·sinλ
z=r·sinφ.

The image of the spherical surface onto which the 360-degree video has been mapped in this way is projected onto the imaging plane by perspective projection transformation and displayed. Note that this mapping can be easily implemented by using 3D development software such as Unity.

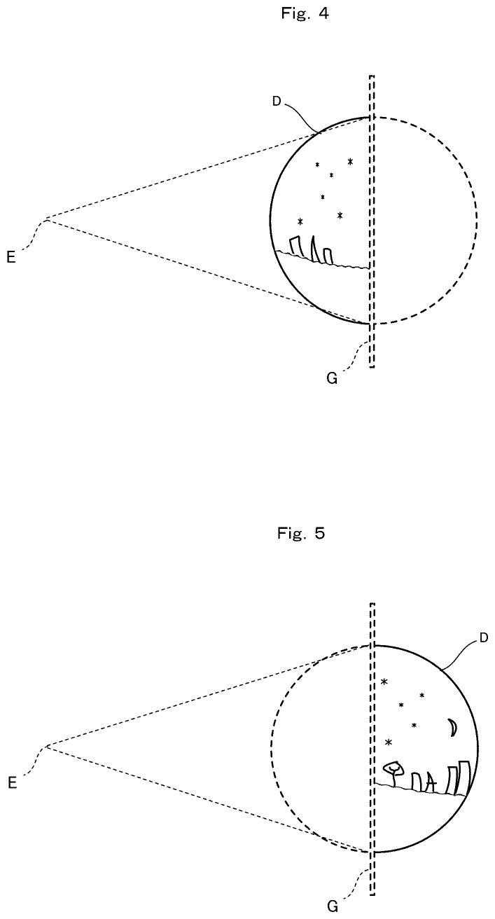

When a 360-degree video is mapped onto a spherical surface in this manner, the image on the front side as seen from viewpoint E outside the sphere D will be horizontally reversed (see FIG. 4). For example, when representing a starry sky as in this example, constellations and the like will all be mirror images. As will be explained later, in this embodiment, the sphere D onto which the image is mapped can be freely rotated around any axis, so the entire starry sky can be observed from a bird's-eye view, just as if one were handling a celestial globe.

In this instance, the background of the starry sky is black, so the rear side is visible as is. Therefore, if the opposite surface (the back side of the sphere D) were displayed, the image on the front side would become difficult to see. For this reason, the opposite surface of the sphere D is removed here by culling processing.

Additionally, since a captured starry sky is used in this example, the starry sky is not visible in the hemisphere on the ground side; however, it is also possible to make it a sphere equivalent to a celestial globe by displaying the corresponding starry sky (mainly the starry sky of the Southern Hemisphere) in the ground-side hemisphere as well. In this case, a plurality of images, including 360-degree images of the Southern Hemisphere's starry sky captured in real life, may be connected to form a full-sphere starry sky, or the arrangement of stars may be reconstructed on a computer like a planetarium.

On the other hand, in general images, mirror images often feel out of place. In such cases, the mapping is not performed on the front spherical surface of the sphere D as seen from viewpoint E, and mapping is performed only on the back spherical surface of the sphere D. By doing so, one views the inner surface of the back side from the inside of the sphere D (see FIG. 5). In this way, the user can appreciate the 360-degree video on the spherical surface as a normal (non-reversed) image. Of course, in the case of the starry sky, by mapping the image to the back side of the sphere to display it as a normal image, constellations and the like can be seen in their actual arrangement.

Furthermore, in this embodiment, the sphere (image) can also be scaled up or down by predetermined gestures. For example, if the index finger and thumb are brought together (as if pinching) and the hand is moved forward, the display of the three-dimensional object expands; conversely, if the index finger and thumb are brought together and the hand is moved backward, the display of the three-dimensional object shrinks. These correspond to pinch-out and pinch-in operations for scaling on a touch panel. Of course, instead of the gesture of bringing the index finger and thumb together, a gesture of moving the hand back and forth with a thumbs-up may be used.

Accordingly, the user can rotate the sphere so that the part of interest is directly in front and perform the above gesture to enlarge and display a portion of the front. For example, when enlarged, an effect as if one has entered the inside of the sphere to observe can be expected.

### Rotation of the Sphere

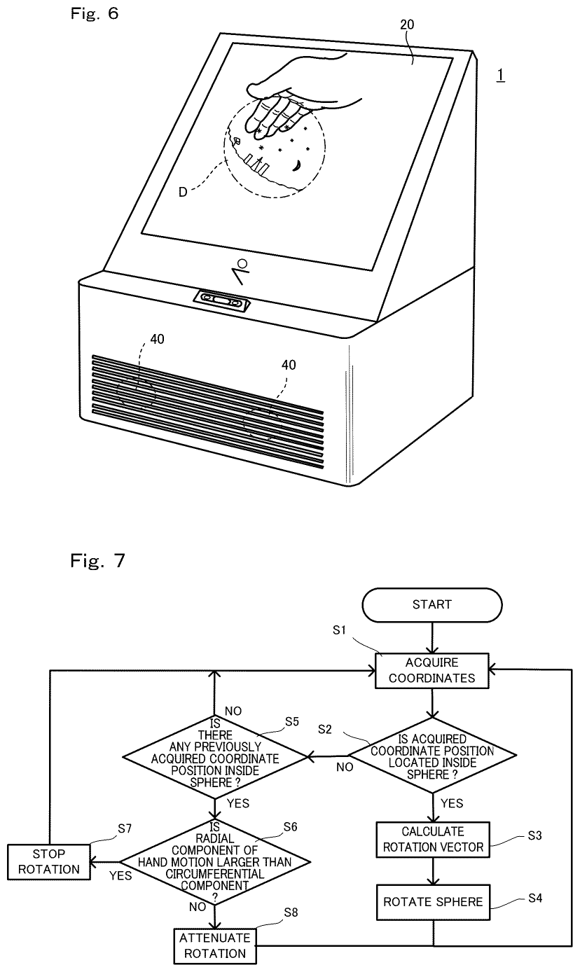

The sphere D, onto which this 360-degree video is mapped, can be rotated by hand gestures. Control of the rotation of the sphere D by gestures is performed just like stroking and moving the surface of a sphere floating in the air (see FIG. 6). When the coordinates of the user's hand detected by the motion sensor 7 are inside the coordinates of the surface of the sphere D, it is recognized that there is interference between the user's hand and the sphere D, and the sphere D is rotated according to the movement of the user's hand. In particular, the user can freely rotate the image on the surface of the sphere D vertically, horizontally, and diagonally by moving their hands vertically, horizontally, and diagonally.

When the system starts, the acquisition of the coordinates of the user's hand detected by the motion sensor 7 is repeatedly performed along with the mapping of the 360-degree video onto the surface of the sphere D. Then, every time coordinates are acquired, it is determined whether or not these coordinates are located inside the sphere D. If the hand coordinates are inside the sphere, the movement of the user's hand is calculated. Here, the movement of the user's hand is calculated as the difference between the previously acquired coordinates and the currently acquired coordinates. The calculated movement of the user's hand is converted into a rotation vector with the center of the sphere D (the center of rotation) as the origin, and the 360-degree video is redrawn after rotating the sphere D by the rotation vector. In this way, the movement of the user's hand can be reflected in the rotation of the sphere D.

If the coordinates of the user's hand acquired by the motion sensor 7 are outside the sphere, it is determined whether or not the previously acquired coordinates were located inside the sphere. If the previously acquired coordinates were not located inside the sphere D, the acquisition of the user's hand coordinates is repeated without performing any specific processing here. If the previously acquired coordinates were located inside the sphere D, it is determined that the user touched and rotated the sphere D with their hand and then released their hand from the sphere D to maintain the rotation.

That is, the rotation speed of the sphere D is calculated from the difference between the currently acquired coordinates and the previously acquired coordinates. After the user's hand moves outside the sphere D, the sphere D continues to rotate according to this rotation speed, independently of the user's hand movement. However, this rotation speed attenuates according to a certain attenuation coefficient.

If the user wishes to stop the sphere D in a specific posture, the user pulls their hand straight out from the sphere D in the radial direction from the center so as not to rotate the sphere D. To detect that intention, the radial component of the difference between the currently acquired coordinates and the previously acquired coordinates is compared with the other components (circumferential components). Then, if the radial component is larger than the circumferential component, the circumferential component is ignored (replaced with 0), and the sphere D is fixed at the current position. Conversely, if the radial component is not larger than the circumferential component, the sphere D is rotated according to the circumferential component.

The overall flow of the above processing will be explained in more detail with reference to the flowchart in FIG. 7. First, in step S1, the coordinates of the user's hand are acquired by the motion sensor 7. Here, the coordinates of the fingertips are acquired. Therefore, when both hands are used, a maximum of 10 coordinates are acquired. Note that the center of the sphere D displayed here is the center of rotation, the center of the imaging region, and the origin of the coordinate system. The vector from the origin of this coordinate system to each set of coordinates will be referred to as a coordinate vector.

Next, in step S2, it is determined whether or not the coordinate position corresponding to each acquired coordinate set is located inside the sphere D. If it is determined that at least one coordinate position is located inside the sphere D (YES in step S2), the movement of the user's hand is calculated for each coordinate position located inside the sphere D as the difference between the previously acquired coordinate vector and the currently acquired coordinate vector, and a rotation vector v linked to the hand movement is determined (step S3).

Specifically, letting the currently acquired coordinate vector be rᵢ and the previously acquired coordinate vector be rᵢ′, individual rotation vectors vᵢ (where index i is 1 to n: maximum 10) are calculated. Here, using × as the cross product, it is simply calculated as vᵢ=(rᵢ×rᵢ′)/|rᵢ|. Assuming that the rotation vector vᵢ is very small, the target rotation vector v is taken as the average of the rotation vectors vᵢ, i.e., Σvᵢ/n.

Next, the sphere D is rotated using the determined rotation vector v (step S4). That is, letting the coordinates of each point on the sphere D be p, the point p′ after rotation is obtained by the following formula. Here, × means the cross product and · means the inner product.

$${p}^{′} = p cos \vert v \vert + {\vert v \vert}^{- 2} v ( v \cdot p ) ( 1 - cos \vert v \vert ) + {\vert v \vert}^{- 1} ( v \times p ) sin \vert v \vert$$

If it is determined in step S2 that all of the acquired coordinate positions are located outside the sphere D (NO in step S2), it is determined whether any of the previously acquired coordinate positions were located inside the sphere D (step S5). If any of the previously acquired coordinate positions were located inside the sphere D (YES in step S5), it is determined that the user touched and rotated the sphere D and then released their hand from the sphere D.

In the case of YES in step S5, the radial component and the circumferential component of the difference (rᵢ−rᵢ′) between the currently acquired coordinate position and the previously acquired coordinate position are compared (step S6). To do this, the cross product and inner product of the currently acquired coordinate vector and the differential vector may be calculated to determine which is larger.

That is, if (rᵢ−rᵢ′)·rᵢ>|(rᵢ−rᵢ′)×rᵢ|, it is determined that the radial component is larger (YES in step S6), the rotation of the sphere D is stopped, and it is fixed at the current position (step S7). This allows the user to intentionally stop the sphere D in a specific posture by pulling their hand outward from the sphere D.

If (rᵢ−rᵢ′)·rᵢ≤|(rᵢ−rᵢ′)×rᵢ|, it is determined that the circumferential component is larger (NO in step S6), and it is determined that the user intends to let the sphere D rotate freely even after releasing their hand. Therefore, the rotation vector v is calculated from the coordinate vectors rᵢ and rᵢ′ as described above. Even after the user moves their hand outside the sphere D, the rotation of the sphere D continues according to the rotation vector v.

The rotation vector v corresponds to the angular velocity ω (=|v|/d), where d is the coordinate acquisition interval. While it is possible to continue rotating the sphere D at this angular velocity ω, in the real world, even if an object is floating in the air, the rotation gradually attenuates due to air resistance. Therefore, an attenuation simulation is also performed here (step S8).

Since air resistance is proportional to the angular velocity ω, the equation of motion is Cω=−Mdω/dt, where C is a coefficient and M is the moment of inertia. To implement this, assuming the display of the sphere D is updated at the coordinate acquisition interval d, the angular velocity ω may be multiplied by a constant attenuation coefficient at each interval d. For example, if the attenuation coefficient is 0.9, the angular velocity is approximately halved every time 7d elapses. Increasing this attenuation coefficient will cause the sphere D to stop more slowly.

In the above embodiment, operations using both hands are also possible. For example, if the left hand is kept still inside the sphere D while the right hand rotates the sphere, the movements of the left and right hands are averaged; thus, it becomes possible to control finer movements with the right hand while applying a brake with the left hand.

Note that in the above embodiment, the program can also be designed so that the sphere (image) can be scaled up or down by predetermined gestures. If this scaling function is not implemented, the size of the sphere is fixed, and only the circular region in the center of the screen of the liquid crystal display 10 (the display region of the sphere) is always used for display.

Additionally, in liquid crystal displays, it is impossible to achieve perfect black due to structural reasons, and in regions other than the circular region (set to black) that are not supposed to emit light, some light leakage from the backlight inevitably occurs. This is reflected in the imaging region G, creating the possibility that the floating sensation or three-dimensional effect of the sphere may be slightly diminished.

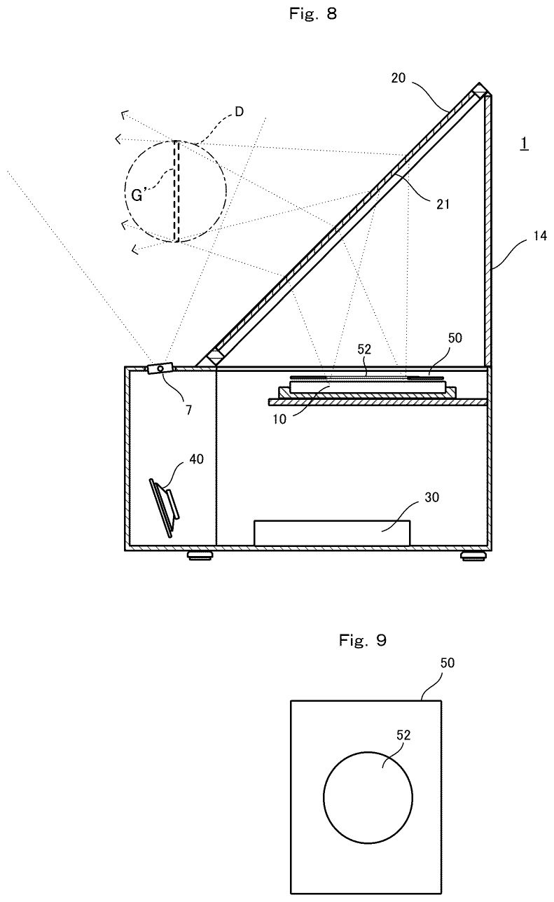

Therefore, when the sphere size is fixed, it is effective to cover the display screen of the liquid crystal display 10 other than the circular region with a light-shielding plate 50, as shown in FIG. 8. That is, the light-shielding plate 50 has a size capable of covering the entire display screen of the liquid crystal display 10, and an opening 52 of the same size as the circular region is formed in the center (see FIG. 9). With the light-shielding plate 50 installed on the display screen of the liquid crystal display 10, the circular region displayed on the display screen (the display region of the sphere) and the opening 52 of the light-shielding plate 50 align precisely. As a result, the region outside the circular region corresponding to the sphere is completely shielded from light.

Accordingly, only the display of the sphere on the liquid crystal display 10 forms an image, and no image is formed in other regions. That is, the imaging region is limited to a narrower region G′. This achieves a prominent floating sensation for the sphere, and when a rotation gesture is performed, a greater sense of actually touching the sphere can be obtained.

According to the aerial image display device for displaying 360-degree images relating to the present invention, by using a spherical surface as a screen, it is possible to provide an aerial image display device that can be visually recognized over a wide area of 360-degree space. Such an aerial image display device can provide users with a visual experience unlike anything they have seen before.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

For example, in the above embodiment, the video to be mapped onto the spherical surface is input as a two-dimensional image expressed by equirectangular projection, but this is merely an example, and other formats may be used. For example, any format representing an image captured over the entire circumference of a single viewpoint, such as using a combination of two dome master format images, can be utilized similarly.

Furthermore, the 360-degree images used here include not only 360-degree videos but also 360-degree still images. If a 360-degree still image is displayed on a spherical surface, the state of the entire circumference as seen from a certain position can be observed slowly.

In addition, the above embodiment adopts an aerial image display device using a retro-transmissive optical imaging element. However, the present invention is not limited to this, and other types of aerial image display devices, such as an aerial image display device using a retro-reflective optical imaging element, may be adopted.

What is claimed is:

1. A method for projecting an image onto an imaging plane in the air with an aerial image display device, the method comprising:
a step of inputting a 360-degree moving image;
a step of defining a sphere in an area in the air including the imaging plane;
a step of mapping the 360-degree moving image onto the surface of the sphere; and
a step of projecting and displaying the surface of the sphere, onto which the 360-degree moving image is mapped, as an aerial image on the imaging plane.

2. The method according to claim 1, wherein the aerial image display device further comprises a motion sensor that detects coordinates of a user's hand located in the vicinity of the aerial image and transmits the detection result to the computer, wherein the motion sensor detects a hand movement performed by the user, rotation of the sphere is performed according to the detection result, and the direction of the rotation vector changes according to the hand movement performed by the user.

3. The method according to claim 1, wherein the 360-degree moving image is an entire celestial sphere image captured by a 360-degree camera.

4. A method for displaying an aerial image with an aerial image display device comprising a computer, an image system controlled by the computer to project an image onto an imaging plane in the air, and a motion sensor that detects coordinates of a user's hand located in the vicinity of the aerial image projected by the image system and transmits the detection result to the computer, the method comprising:
a step of inputting a 360-degree image into the computer;
a step of defining a sphere in an area in the air including the imaging plane;
a step of mapping the 360-degree image onto the surface of the sphere; and
a step of projecting and displaying the surface of the sphere, onto which the 360-degree image is mapped, on the imaging plane;
wherein the motion sensor detects a hand movement performed by the user, rotation of the sphere is performed according to the detection result, the 360-degree image rotates accordingly, and
wherein the user can freely rotate the 360-degree image on the surface of the sphere vertically, horizontally, and diagonally by moving their hand vertically, horizontally, and diagonally.

5. The method according to claim 4 wherein the 360-degree image is a 360-degree moving image.

6. The method according to claim 4 wherein the 360-degree image is an entire celestial sphere image captured by a 360-degree camera.

7. An aerial image display device comprising a computer; a visual system controlled by this computer to project images into the air as aerial images; and a motion sensor that detects the coordinates of a user's hand performed near the projected aerial image and transmits the detection results to the computer, the computer configured to perform:
a step of inputting a 360-degree image into the computer;
a step of defining a sphere in an area in the air including the imaging plane;
a step of mapping the 360-degree image onto the surface of the sphere; and
a step of projecting and displaying the surface of the sphere, onto which the 360-degree image is mapped, on the imaging plane;
wherein the motion sensor detects a hand movement performed by the user, rotation of the sphere is performed according to the detection result, the 360-degree image rotates accordingly, and
wherein the user can freely rotate the 360-degree image on the surface of the sphere vertically, horizontally, and diagonally by moving their hand vertically, horizontally, and diagonally.

8. The aerial image display device according to claim 7 wherein the 360-degree image is a 360-degree moving image.

9. The aerial image display device according to claim 7 wherein the 360-degree image is an entire celestial sphere image captured by a 360-degree camera.
